(19) United States
(12) Patent Application Publication
(10) Pub. No.: US 2014/0013538 A1
(43) Pub. Date: Jan. 16, 2014

(54) AUTONOMOUS VACUUM CLEANER

(71) Applicants: James Dyson, Malmesbury (GB); Peter David Gammack, Malmesbury (GB)

(72) Inventors: James Dyson, Malmesbury (GB); Peter David Gammack, Malmesbury (GB)

(73) Assignee: DYSON TECHNOLOGY LIMITED, Malmesbury, Wiltshire (GB)

(21) Appl. No.: 13/983,475

(22) PCT Filed: Jan. 13, 2012
(86) PCT No.: PCT/GB2012/050065

§ 371 Date: Sep. 27, 2013

(30) Foreign Application Priority Data
Feb. 4, 2011 (GB) 1101940.3

(51) Int. Cl. A47L 9/16

(52) U.S. Cl. CPC A47L 9/1625; A47L 9/1633
USPC 15/353

(57) ABSTRACT

An autonomous vacuum cleaner comprising a chassis, a traction part for supporting the vacuum cleaner on a surface, a driving part for driving the traction part and a control system configured to control the driving part to guide the vacuum cleaner across a surface to be cleaned. The vacuum cleaner further includes a cleaner head having a dirty air inlet facing the surface to be cleaned and a separating apparatus carried by the chassis and communicating with the cleaner head in order to separate debris from an airflow entering the separating apparatus via the dirty air inlet. The separating apparatus comprises a first upstream cyclone and a plurality of second cyclones arranged in parallel with one another and located downstream of the first cyclone.

### REFERENCE TO RELATED APPLICATIONS

This application is a national stage application under 35 USC 371 of International Application No. PCT/GB2012/050065, filed Jan. 13, 2012, which claims the priority of United Kingdom Application No. 1101940.3, filed Feb. 4, 2011, the entire contents of which are incorporated herein by reference.

### FIELD OF THE INVENTION

This invention relates to an autonomous vacuum cleaner, also known generally in the art as ‘robotic’ vacuum cleaners.

### BACKGROUND OF THE INVENTION

Robotic vacuum cleaners, in general, are known and represent a relatively recent but rapidly advancing field of floor cleaning technology. The main advantage of robot vacuum cleaners over manually operated vacuum cleaners is that a robot vacuum cleaner has the facility to guide itself around an area to be cleaned, be it an entire floor of a property or a single room, and so is capable of operating completely or at least largely autonomously and free from human involvement.

Some examples of known robotic vacuum cleaners are described in EP0803224A, U.S. Pat. No. 5,787,545, WO97/41451 and U.S. Pat. No. 7,636,982. In the known robotic vacuum cleaners, the separating apparatus employed to separate the dirt and dust from the inducted airflow takes the form of a bag-type filter or an equivalent container type filter. The drawback with these arrangements is that as the bag, or container, fills up with debris it will become clogged so that the cleaning performance of the machine will suffer over time. More generally, cleaning performance tends to be less than satisfactory since the focus is on providing the vacuum cleaner with a sophisticated autonomous control system and a rather basic floor cleaning scheme to sweep dirt and dust from the floor rather than providing a powerful suction action as is found on upright type vacuum cleaners, for example. To date, therefore, robotic vacuum cleaners tend to be regarded as appliances which do not rival upright and cylinder vacuum cleaners for cleaning performance.

### SUMMARY OF THE INVENTION

It is against this background that the invention provides an autonomous vacuum cleaner comprising a chassis, traction means for supporting the vacuum cleaner on a surface, drive means for driving the traction means and a control system configured to control the drive means to guide the vacuum cleaner across a surface to be cleaned, wherein the vacuum cleaner further includes a cleaner head having a dirty air inlet facing the surface to be cleaned and a separating apparatus carried by the chassis and communicating with the cleaner head in order to separate debris from an airflow entering the separating apparatus via the dirty air inlet, wherein the separating apparatus comprises a first upstream cyclone and a plurality of second cyclones arranged in parallel with one another and located downstream of the first cyclone.

By providing a robotic vacuum cleaner with a cyclonic separating apparatus having two stages of cyclones, a first upstream cyclone and a plurality of downsteam parallel cyclones, the cleaning efficiency of the appliance is improved significantly compared with known robotic cleaners. Therefore, the performance of the robotic vacuum cleaner of the invention is comparable or potentially exceeds that of the more common manually operated cylinder or upright machines.

In one embodiment, the cyclonic separating apparatus is supported on the chassis so that the longitudinal axis of the separating apparatus is oriented substantially parallel to the chassis. This horizontal orientation of the separating apparatus permits the separating apparatus to be lengthened, therefore increasing its dust capacity without increasing the height of the vacuum cleaner. In such an arrangement, the inlet to the separating apparatus is positioned directly above an outlet of the cleaner head which enables a substantially straight flow path between the cleaner head and the inlet of the cyclonic separating apparatus. This configuration helps to minimize the pressure drop in the region between the cleaner head and the separating apparatus.

In an alternative embodiment, the cyclonic separating apparatus is supported on the chassis with the longitudinal axis of the separating apparatus oriented substantially perpendicular to the chassis. This arrangement enables the vertical height of the separating apparatus to be configured so that it does not extend beyond the upper surface of the vacuum cleaner.

To ensure the cyclonic separator is compact, the plurality of second cyclones may be arranged radially around a longitudinal axis of the first cyclone, and within the first cyclone. Furthermore, the first cyclone may be substantially cylindrical in shape, primarily due to the shape of the outer housing of the cyclone separating apparatus, and the plurality of downstream cyclones may be frustoconical in shape so as to promote a high speed airflow thereby increasing separating efficiency, particularly of small particles.

Beneficially, the cyclonic separating apparatus may be housed within a container that is removably mounted to the chassis of the vacuum cleaner and which, in use, serves to collect the dirt and dust that is drawn in through the cleaner head and that is separated from the airflow by the separating apparatus.

### BRIEF DESCRIPTION OF THE DRAWINGS

In order that the invention may be more readily understood, currently preferred embodiments will now be further described by way of example with reference to the accompanying drawings, in which:

FIG. 1 is a perspective view of a vacuum cleaner of the invention;

FIG. 2 is a plan view of the vacuum cleaner of FIG. 1;

FIG. 3 is a rear view of the vacuum cleaner of FIG. 1;

FIG. 4 is a side view of the vacuum cleaner of FIG. 1;

FIG. 5 is a view from below of the vacuum cleaner of FIG. 1; and

FIG. 6 is a part sectioned view along the line V-V of FIG. 2.

### DETAILED DESCRIPTION OF THE INVENTION

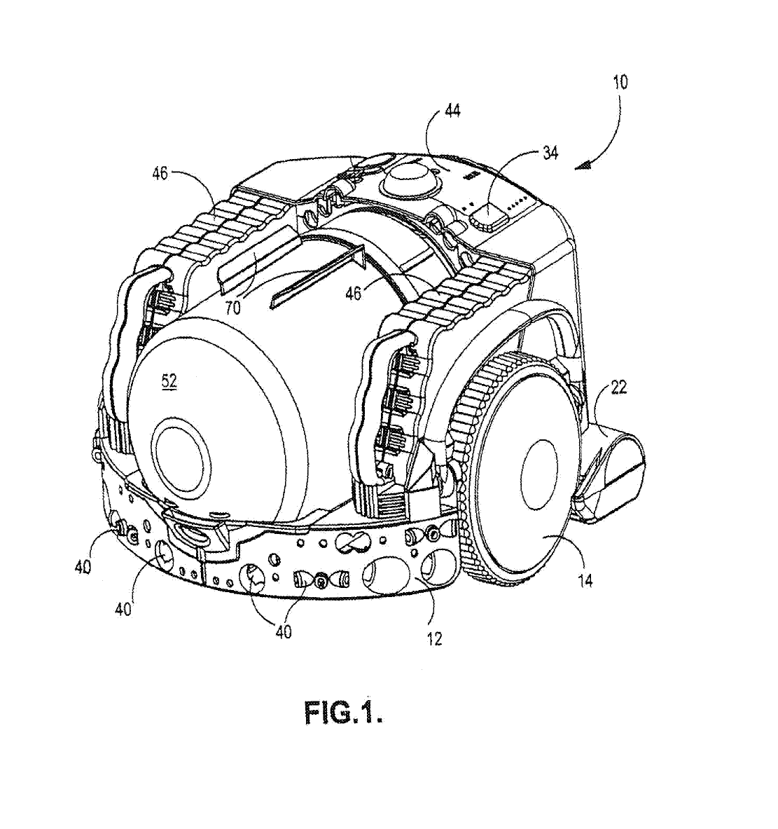

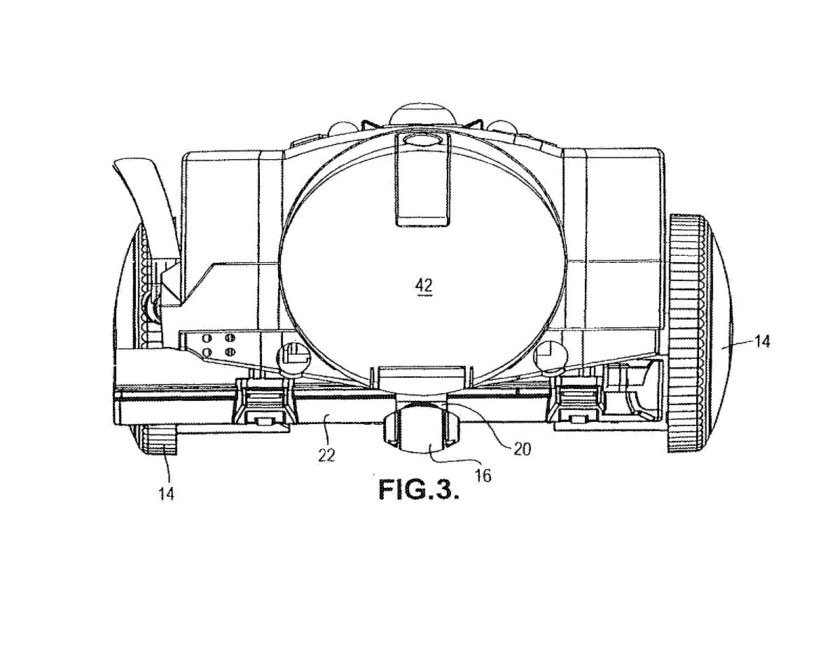

Referring firstly to FIGS. 1 to 5, a vacuum cleaner 10 has a supporting chassis 12 which is generally circular in shape and is supported on two driven traction wheels 14 and a castor wheel 16. The chassis 12 is preferably manufactured from high-strength moulded plastics material, such as ABS, but can equally be made from metal such as aluminium or steel. The chassis 12 provides support for the components of the vacuum cleaner 10 which will be described in more detail below.

The driven wheels 14 are arranged diametrically opposed at either side of the chassis 12, and therefore share an axis that is perpendicular to the longitudinal axis of the vacuum cleaner 10 which, it should be noted, is oriented along the direction of travel of the vacuum cleaner 10. Each driven wheel 14 is moulded from a high-strength plastics material and carries a comparatively soft, ridged band around its circumference to enhance the grip of the wheel when the vacuum cleaner 10 is traversing a smooth floor. The driven wheels 14 are mounted independently of one another via support bearings (not shown) and each driven wheel 14 is connected directly to a motor which is capable of driving the respective wheel in either a forward direction or a reverse direction. By driving both wheels forward at the same speed, the vacuum cleaner 10 can be driven in a forward direction and, conversely, it can be driven is a backward direction by driving both wheels in a reverse direction at the same speed. By driving the wheels in opposite directions, the cleaner can be made to rotate about its own central axis so as to make a turning manoeuvre. The aforementioned method of driving a vehicle is well known and will not therefore be described any further here.

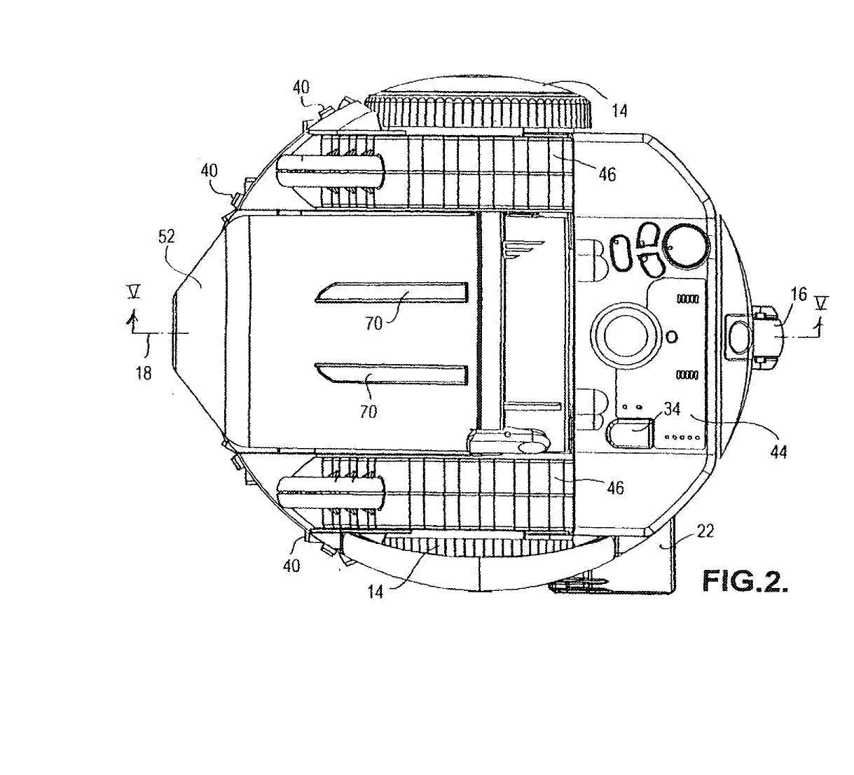

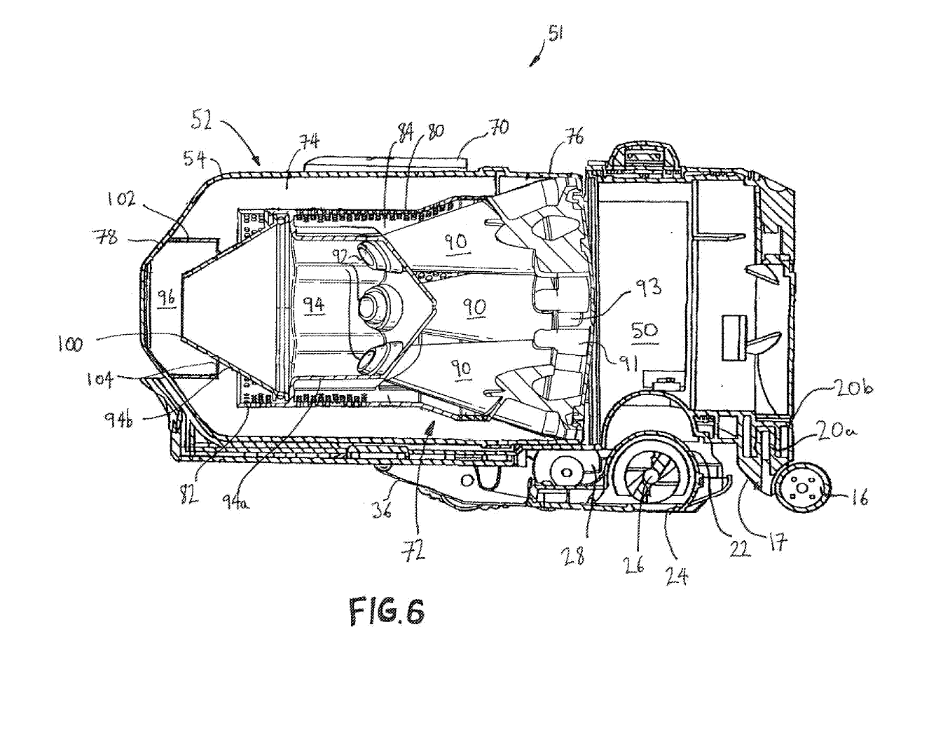

The castor wheel 16 is significantly smaller in diameter than the driven wheels 14 as can be seen from, for example, FIG. 2. The castor wheel 16 is not driven and merely serves to support the chassis 12 at the rear of the vacuum cleaner 10. The location of the castor wheel 16 at the trailing edge of the chassis 12, and the fact that the castor wheel 16 is swivel-mounted on the chassis 12 by means of a swivel joint 20, allows the castor wheel 16 to trail behind the vacuum cleaner 10 in a manner which does not hinder the manoeuvrability of the vacuum cleaner 10 whilst it is being driven by way of the driven wheels 14. The swivel joint 20 is most clearly shown in FIG. 6.

The castor wheel 16 is fixedly attached to an upwardly extending cylindrical member 20a which is received by an annular housing 20b to allow free rotational movement of the cylindrical member 20a within it. This type of arrangement is well known. The castor wheel 16 can be made from a moulded plastics material or can be formed from another synthetic material such as nylon.

Mounted on the underside of the chassis 12 is a cleaner head 22 which includes a suction opening 24 facing the surface on which the vacuum cleaner 10 is supported. The suction opening 24 is essentially rectangular and extends across the majority of the width of the cleaner head 22. A brush bar 26 is rotatably mounted in the suction opening 24 and a motor 28 is mounted on the cleaner head 22 for driving the brush bar 26 by way of a drive belt (not shown) extending between a shaft of the motor 28 and the brush bar 26.

The cleaner head 22 is mounted on the chassis 12 in such a way that the cleaner head 22 is able to float on the surface to be cleaned. This is achieved in this embodiment in that the cleaner head 22 is pivotally connected to an arm (not shown) which in turn is pivotally connected to the underside of the chassis 12. The double articulation of the connection between the cleaner head 22 and the chassis 12 allows the cleaner head 22 to move freely in a vertical direction with respect to the chassis 12. This enables the cleaner head 22 to climb over small obstacles such as books, magazines, rug edges, etc. Obstacles of up to approximately 25 mm in height can be traversed in this way.

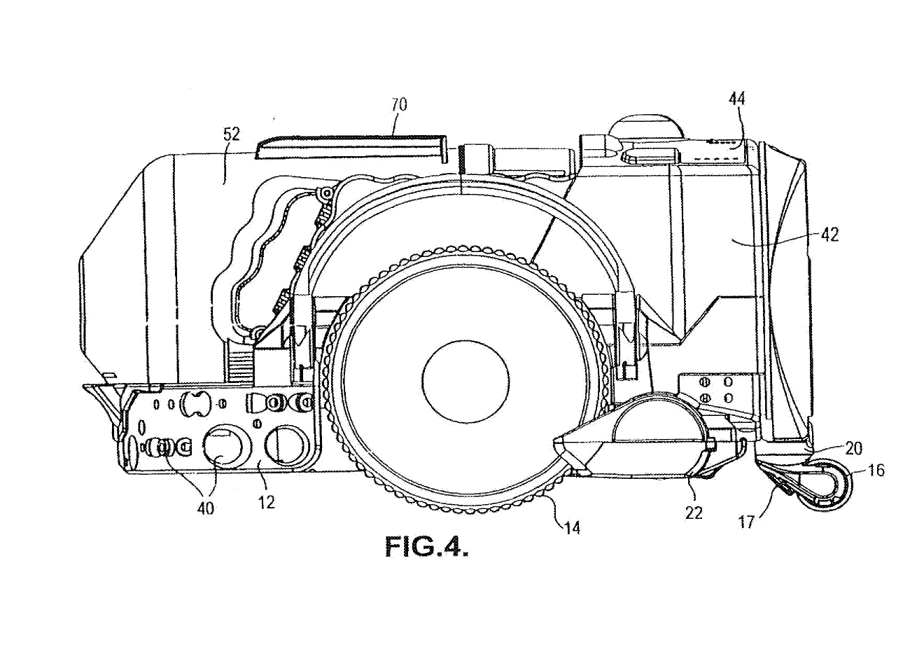

In order to assist the cleaner head 22 to move vertically upwards when an obstacle is encountered, forwardly projecting ramps 36 are provided at the leading edge of the cleaner head 22. In the event that an obstacle is encountered, the obstacle will initially abut against the ramps 36 and the inclination of the ramps 36 will then lift the cleaner head 22 over the obstacle in question so as to avoid the cleaner from becoming lodged against the obstacle. The cleaner head 22 is shown in a lowered position in FIG. 6 and in a raised position in FIG. 4. The castor wheel 16 also includes a ramped portion 17 which provides additional assistance when the vacuum cleaner 10 encounters an obstacle and is required to climb over it. In this way, the castor wheel 16 will not become lodged against the obstacle after the cleaner head 22 has climbed over it.

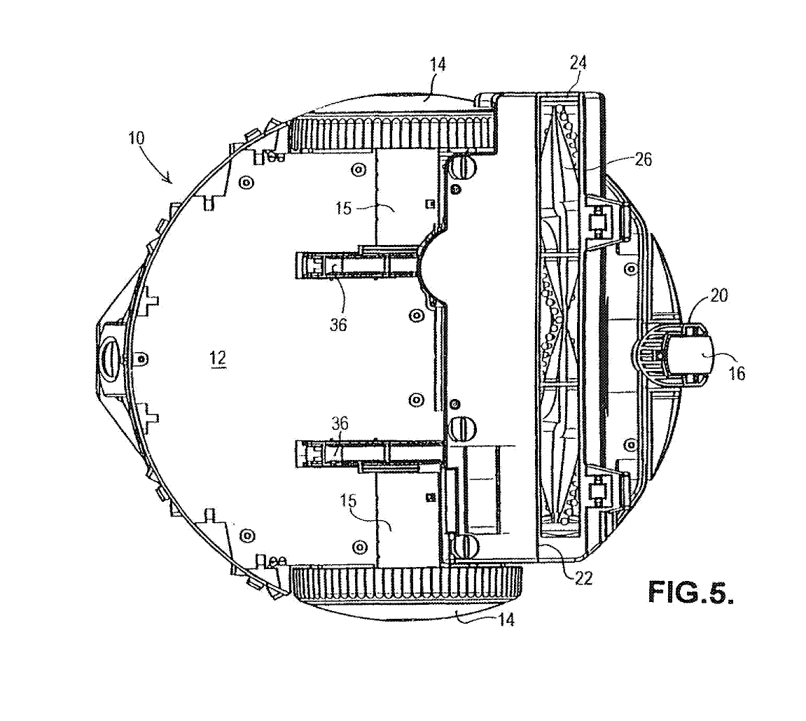

As can be seen from FIGS. 2 and 5, the cleaner head 22 is asymmetrically mounted on the chassis 12 so that one side of the cleaner head 22 protrudes beyond the general circumference of the chassis 12. This allows the vacuum cleaner 10 to clean up to the edge of a room on the side of the vacuum cleaner 10 on which the cleaner head 22 protrudes.

The chassis also carries a plurality of sensors 40 which are designed and arranged to detect obstacles in the path of the vacuum cleaner 10 and its proximity to, for example, a wall or other boundary such as a piece of furniture. The sensors 40 comprise several ultra-sonic sensors and several infra-red sensors. The array illustrated in FIGS. 1 and 4 is not intended to be limiting and the arrangement of the sensors does not form part of the present invention. Suffice it to say that the vacuum cleaner 10 carries sufficient sensors and detectors to enable it to guide itself autonomously around a predefined area so that the said area can be cleaned.

Control software, comprising navigation controls and steering devices, is housed within a housing 42 located beneath a control panel or elsewhere within the cleaner. Battery packs 46 are mounted on the chassis inwardly of the driven wheels 14 to provide power to the motors for driving the wheels and to the control software. The battery packs 46 are removable to allow them to be transferred to a battery charger (not shown).

The vacuum cleaner also includes a motor and fan unit 50 supported on the chassis 12 for drawing dirty air into the vacuum cleaner 10 via the suction opening 24 in the cleaner head 22. The chassis 12 also carries a cyclonic separator 51 for separating dirt and dust from the air drawn into the vacuum cleaner 10. The cyclonic separator 51 is shown externally from various angles in FIGS. 1 to 4, and its internal features are best appreciated in FIG. 6.

The cyclonic separator 51 takes the form of a generally cylindrical bin 52 that defines an inner chamber, the bin 52 being oriented such that its longitudinal axis is substantially horizontal when the cyclonic separator 51 is in a ‘docked’ position on the vacuum cleaner 10, as shown in FIG. 6. The outer wall 54 that defines the bin 52 is preferably of transparent plastics so allowing a use to view the interior of the bin, although it should be appreciated that this is not essential to the invention. Located on the outer surface of the bin 52 are elongate gripping rails 70 that help a user remove the bin 52 from the chassis 12 for emptying purposes. For a clean profile, the gripping rails 72 are a moulded feature integral with the bin 52 and extend outwardly a short way sufficient to enable a user's hand to find good purchase on the gripping rails 70.

Broadly, the cyclonic separator 51 includes a secondary cyclone assembly 72 that is mounted within the bin 52 with the result that a primary cyclone chamber 74 or ‘first cyclone’ is defined around the outside of the secondary cyclone assembly 72. Referring firstly to the first cyclone 74, it should be appreciated that in this context the term ‘cyclone’ is used in the sense of a chamber within which a cyclone of air will be generated, in use, rather than an actual flow of air per se. This use of the term is customary in the art.

The first cyclone 74 has an entry or inlet portion 76 that is formed in an upper section of the bin 52 (seen to the left in FIG. 6). The entry portion 76 is in communication with the suction opening 24 of the cleaner head 22 via the inlet port (not shown) and thereby forms a communication path between the suction opening 24 and the interior of the first cyclone 74. The inlet port and the entry portion 76 are arranged to admit air tangentially to the first cyclone 74 so that the incoming air is forced to follow a helical path around the interior of the first cyclone 74. At the end of the bin 52 remote from the entry portion 76, the bin 52 is closed by a generally frustoconical end portion 78.

Although not shown in the figures, a flexible connector is located between a rear portion of the cleaner head 22 and the inlet port located in the chassis and which serves to fluidly connect the cleaner head 22 to the cyclonic separator 51. The flexible connector consists of a rolling seal, one end of which is sealingly attached to the upstream mouth of the inlet port and the other end of which is sealingly attached to the cleaner head 22. When the cleaner head moves upwardly with respect to the chassis 12, the rolling seal distorts or crumples to accommodate the upward movement of the cleaner head 22. Conversely, when the cleaner head 22 moves downwardly with respect to the chassis 12, the rolling seal unfolds or extends into an extended position to accommodate the downward movement. The rolling seal may alternatively be in the form of a tubular bellows arrangement.

It should be noted that since the first cyclone 74 is arranged horizontally, so that its longitudinal axis is parallel with the chassis 12, the entry portion 76 is usefully positioned substantially directly above the suction opening 24 of the cleaner head 22 so that a straight airflow path exists between the suction opening and the interior of the first cyclone 74. This arrangement helps to avoid a significant pressure drop in this region of the vacuum cleaner.

Referring now in more detail to the secondary cyclone assembly 72, a shroud 80 in the form of a generally cylindrical perforated wall provides an outlet path for air in the first cyclone 74 and defines a channel 84 leading to a plurality of second cyclones 90, shown in FIG. 6 in the form of conical chambers. Note that although the shroud 80 is perforated with through-holes, it may instead be made air-permeable by other ways, for example it may be made from a mesh or like structure.

A lip 82 is provided at the base of the shroud 80, the lip 82 also being provided with a plurality of through-holes which are designed to allow air to pass through but to capture dirt and dust.

The plurality of second cyclones 90 are arranged in parallel with one another and downstream of the first cyclone. In this embodiment, six second cyclones are provided although it should be appreciated that more cyclones may be provided if desired, and if packaging constraints permit, in order to further increase the separation efficiency of the vacuum cleaner. The second cyclones 90 are arranged equi-angularly around the longitudinal axis of the bin 52 and also, therefore, of the first cyclone 74. Each second cyclone 90 has a tangentially-arranged air inlet 91 at its upper end and a centrally disposed air outlet 93 also located at the upper end where the cyclones 90 are largest in diameter. A cone opening 92 is located at a second end of each second cyclone 90 (opposite the upper end), at the smallest diameter section of the cyclones 90 and within a cyclone exit chamber 94 that is defined by a cylindrical wall located radially inward of, and concentric with, the shroud 80.

Note that the term ‘downstream’ and ‘upstream’ with respect to the first and second cyclones is used in the sense that the airflow first goes through the first cyclone and then continues to the second cyclones, so that the second cyclones are downstream of the first cyclones. Likewise, the first cyclone is upstream of the second cyclones.

The plane of the cone opening 92 of each second cyclone 90 is angled inwardly with respect to a longitudinal axis (not shown) which serves to converge the dirt exiting from the openings towards the centre of the cyclone exit chamber 94 and in the direction of a fine dust collecting chamber 96 located downstream of the exit chamber 94.

In more detail, the cyclone exit chamber 94 has a first wall portion 94a having a relatively wide diameter and a second wall portion 94b which is frustoconical and tapers to form an outlet aperture 100. Dust exits the outlet aperture 100 and collects in the fine dust chamber 96 that is defined by a cylindrical wall 102 upstanding from the base 78 of the bin 52. The wall 102 is provided with a flexible (e.g. rubber or flexible polymer) lip 104 with which the conical portion of the exit chamber 94 engages and seals.

The vacuum cleaner 10 described above operates in the following manner. In order for the cleaner 10 to traverse the area to be cleaned, the wheels 14 are driven by the motors 15 which, in turn, are powered by the batteries 46. The direction of movement of the cleaner 10 is determined by the control system which communicates with the sensors 40 which are designed to detect any obstacles in the path of the cleaner 10 so as to navigate the cleaner 10 around the area to be cleaned. Methodologies and control systems for navigating a robotic vacuum cleaner around a room or other area are well documented elsewhere and do not form part of the inventive concept of this invention. Any of the known methodologies or systems could be implemented here to provide a suitable navigation system.

The batteries 46 also provide power to operate the motor and fan unit 50 to draw air into the cleaner 10 via the suction opening 24 in the cleaner head 22. The brush bar motor 28 is also driven by the batteries 46 so that the brush bar 26 is rotated in order to achieve good pick-up, particularly when the cleaner 10 is to be used to clean a carpet. In use, when the robot vacuum cleaner 10 is performing a cleaning operation, the motor and fan unit draws a flow of dirt-laden air through the suction opening 24 and into the inlet port and then into the cyclonic separator 51. Dirt-laden air enters the first cyclone 74 through the entry portion 76 and, due to the tangential arrangement of the entry portion 76, the airflow is forced to follow a spiralling helical path around the interior of the outer wall 54, by which filtering action larger dirt and dust particles are separated by cyclonic action and collect in the region of the base of the bin 52.

The partially-cleaned airflow then flows back up the interior of the first cyclone 74 and exits the first cyclone via the through-holes in the shroud 80, after which the airflow enters the outlet channel 84 and from there is divided between the tangential inlets 91 of each of the second cyclones 90. It should be noted that since each of the second cyclones 90 has a smaller diameter than that of the first cyclone 74, they are able to separate smaller particles of dirt and dust from the partially-cleaned airflow than the first cyclone 74, thus providing increased separation efficiency compared to known autonomous vacuum cleaners. Separated dirt and dust exits the second cyclones 90 via the cone openings 92 and thereafter passes down the cyclone exit chamber 94 and into the dust collecting chamber 96.

Cleaned air then flows back up the second cyclones 90, exiting through the respective air outlets 93 and is passed over or around the motor and fan unit 50 in order to cool the motor before the air is expelled into the atmosphere. Although not shown specifically in the figures, it should be appreciated that a filter may also be provided downstream of the motor and fan unit 50 in order further to filter the exhausted air, and primarily to remove very fine particles that may remain in the airflow, particularly carbon particles that may be shed from the motor.

The entire cyclonic separator 51 is releasable from the chassis in order to allow emptying of the first (outer) and second (inner) cyclones. A hooked catch (not shown) is provided adjacent the inlet port by means of which the cyclonic separator 51 is held in position when the vacuum cleaner 10 is in use. The hooked catch is released by manual pressing of a button located in the control panel, whereby the cyclonic separator 51 can be lifted away from the chassis by means of the gripping rails 70. The bin 52 can then be released from the entry portion 76 (which carries with it the shroud and the inner cyclone assembly 72) to facilitate the emptying thereof.

Electronic circuitry for controlling operation of the robotic vacuum cleaner is housed in a lower portion of chassis 12 (see region 90, FIG. 6). Other circuitry is located beneath control panel 44. The circuitry is electrically shielded from electrostatic fields generated by the cyclonic separating apparatus 51 by positioning the circuitry between sheets of electrically conductive material. A first sheet underlies the bin 52. Circuitry is mounted beneath this first sheet and a second sheet lies on the base of the chassis, underneath the circuitry. The sheets are electrically grounded.

The invention is not limited to the precise details of the embodiment described above. Although the cyclonic separator 51 has been described as having a horizontal orientation when it is docked on the robot vacuum cleaner, it should be appreciated that this is not essential and the separator could be inclined relative to the horizontal if desired, for example to increase the effect on gravity in encouraging dust and debris to migrate towards the end part of the bin. Moreover, the bin 52 could be oriented perpendicularly to the chassis 12 if desired, although it would be necessary to reconfigure the shape of the entry portion of the 76 in order to maintain a tangential feed into the entry portion of the cyclonic separator. Also, the number of second cyclones can be varied, as can the detail of their design, such as their cone angle, axis inclination and cone opening inclination.

1. An autonomous vacuum cleaner comprising a chassis, a traction part for supporting the vacuum cleaner on a surface, a driving part for driving the traction part and a control system configured to control the driving part to guide the vacuum cleaner across a surface to be cleaned, wherein the vacuum cleaner further includes a cleaner head having a dirty air inlet facing the surface to be cleaned and a separating apparatus carried by the chassis and communicating with the cleaner head in order to separate debris from an airflow entering the separating apparatus via the dirty air inlet, wherein the separating apparatus comprises a first upstream cyclone and a plurality of second cyclones arranged in parallel with one another and located downstream of the first cyclone.

2. The autonomous vacuum cleaner of claim 1, wherein the cyclonic separating apparatus is supported on the chassis with the longitudinal axis of the separating apparatus oriented substantially parallel to the chassis.

3. The autonomous vacuum cleaner of claim 2 wherein an inlet to the separating apparatus is positioned directly above an outlet of the cleaner head.

4. The autonomous vacuum cleaner of claim 1, wherein the cyclonic separating apparatus is supported on the chassis with the longitudinal axis of the separating apparatus oriented substantially perpendicular to the chassis.

5. The autonomous vacuum cleaner of claim 1, wherein the plurality of second cyclones are arranged radially around a longitudinal axis of the first cyclone.

6. The autonomous vacuum cleaner of claim 1, wherein the upstream cyclone is generally cylindrical in shape, and wherein the plurality of downstream cyclones are frusto-conical in shape.

7. The autonomous vacuum cleaner of claim 1, wherein the cyclonic separating apparatus is housed within a container that is removably mounted to the chassis and in which, in use, collects dirt and dust drawn in through the cleaner head.
